(19) United States
(12) Patent Application Publication
(10) Pub. No.: US 2026/0328301 A1
(43) Pub. Date: Oct. 22, 2026

(54) VALVE ASSEMBLY FOR A FLUID END CARTRIDGE

(71) Applicant: SPM Oil & Gas Inc., Fort Worth, TX (US)

(72) Inventors: Chiawei Steven Su, Arlington, TX (US); Nuder Said, Fort Worth, TX (US)

(73) Assignee: SPM Oil & Gas Inc., Fort Worth, TX (US)

(21) Appl. No.: 19/185,765

(22) Filed: Apr. 22, 2025

(51) Int. Cl. F16K 15/06; E21B 43/26; F04B 53/10

(52) U.S. Cl. CPC F16K 15/066; F04B 53/109; F16K 2200/501

(57) ABSTRACT

A valve cartridge for a fluid pump may include a valve cartridge housing having one or more passageways through the valve cartridge housing that open into a fluid cavity defined in the valve cartridge housing, an annular suction valve configured to control flow from the one or more passageways into the fluid cavity, a guiding insert, and a spring retainer coupled to an end of the guiding insert and retaining a spring between the spring retainer and a backside of the annular suction valve. The annular suction valve has a central opening. The guiding insert extends through the central opening and slidably engages the annular suction valve.

### TECHNICAL FIELD

The present disclosure relates generally to fluid pumps and, for example, to a valve assembly for a fluid end cartridge.

### BACKGROUND

Hydraulic fracturing is a well stimulation technique that typically involves pumping hydraulic fracturing fluid into a wellbore at a rate and a pressure (e.g., up to 15,000 pounds per square inch (psi)) sufficient to form fractures in a rock formation surrounding the wellbore. This well stimulation technique often enhances the natural fracturing of a rock formation to increase the permeability of the rock formation, thereby improving recovery of water, oil, natural gas, and/or other fluids.

A hydraulic fracturing system may employ one or more fluid pumps for pressurizing hydraulic fracturing fluid. A fluid pump has a suction side, at which low-pressure fluid enters the fluid pump via a suction valve to be pressurized, and a discharge side at which high-pressure fluid pressurized by the fluid pump exits the fluid pump via a discharge valve. In some examples, the valves may have guiding components (e.g., legs and/or valve stems) that slide along a surface to keep the valves centered with respect to valve seats, thereby facilitating fluid-tight sealing. However, even slight vertical or lateral movement of a valve that is allowed by a guiding component can result in excessive strike face wear and premature seal failure.

The valve assembly of the present disclosure solves one or more of the problems set forth above and/or other problems in the art.

### SUMMARY

A valve cartridge for a fluid pump may include a valve cartridge housing having one or more passageways through the valve cartridge housing that open into a fluid cavity defined in the valve cartridge housing, an annular suction valve configured to control flow from the one or more passageways into the fluid cavity, a guiding insert, and a spring retainer coupled to an end of the guiding insert and retaining a spring between the spring retainer and a backside of the annular suction valve. The annular suction valve has a central opening. The guiding insert extends through the central opening and slidably engages the annular suction valve.

A valve assembly may include an annular suction valve having a central opening and a groove surrounding the central opening in a backside of the annular suction valve, a guiding insert extending through the central opening and slidably engaging the annular suction valve, a spring partially disposed in the groove, and a spring retainer coupled to an end of the guiding insert and retaining the spring between the spring retainer and the backside of the annular suction valve.

A fluid end of a hydraulic fracturing pump may include a fluid end block having a bore, a plunger configured to reciprocate with respect to the bore, and a valve cartridge. The valve cartridge is configured for insertion and removal from the bore as a unit. The valve cartridge includes a valve cartridge housing, a fluid cavity defined in the valve cartridge housing, and a valve assembly. The valve assembly includes an annular suction valve configured to control flow into the fluid cavity and a guiding insert. The annular section has a central opening. The guiding insert is engaged with the valve cartridge housing along the fluid cavity. The guiding insert extends through the central opening and slidably engages the annular suction valve.

### BRIEF DESCRIPTION OF THE DRAWINGS

FIG. 1 is a cross-sectional view of an example fluid end of a fluid pump.

FIG. 2 is a perspective view of an example valve cartridge of the fluid end of the fluid pump of FIG. 1.

FIG. 3 is a cross-sectional view of the valve cartridge of FIG. 2 taken on plane A-A.

FIG. 4 is an exploded view of an example valve assembly of the valve cartridge of FIG. 2.

### DETAILED DESCRIPTION

This disclosure relates to a valve assembly, which is applicable to any cartridge used in a fluid end of a fluid pump, or any fluid end of a fluid pump. The fluid pump may be a hydraulic fracturing pump.

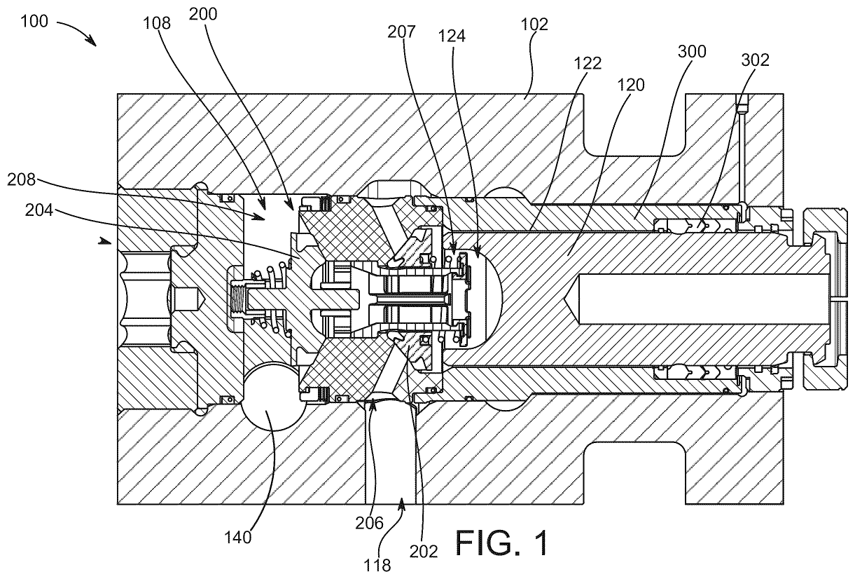

FIG. 1 is a cross-sectional view of an example fluid end 100 of a fluid pump. The fluid pump includes the fluid end 100 and a power end. The fluid end 100 may be connected to the power end by stay rods. The fluid end 100 includes a fluid end block 102 having one or more bores 108 (only one shown). For example, the fluid end 100 may include one, two, three, four, five, or more bores 108. In some implementations, the fluid pump may be mounted on a trailer to facilitate transportation of the fluid pump between operational sites. In some implementations, the fluid pump may be a hydraulic fracturing pump. For example, the fluid pump may have a capability to produce a discharge pressure of at least 8,000 psi, at least 10,000 psi, at least 12,000 psi, or at least 15,000 psi.

The bore 108 is a passageway through the fluid end block 102 of the fluid end 100. The fluid end 100 may include a valve cartridge 200 disposed in the bore 108 (e.g., a respective valve cartridge 200 may be disposed in each bore 108 of the fluid end 100). For example, the valve cartridge 200 is configured for insertion into, and removal from, the bore 108 as a unit. The valve cartridge 200 includes a suction valve 202 (e.g., an annular suction valve) and a discharge valve 204. The suction valve 202 and the discharge valve 204 may have different configurations from that depicted in FIG. 1. The bore 108 may be contoured such that when the valve cartridge 200 is disposed in the bore 108, the valve cartridge 200 partitions the bore 108 into a suction chamber 206, a pressure chamber 207, and a discharge chamber 208 of the bore 108. For example, the suction chamber 206 of the bore 108 may be fluidly connected to a suction manifold 118, and the discharge chamber 208 of the bore 108 may be fluidly connected to a discharge manifold 140. The pressure chamber 207 may be considered downstream of the suction chamber 206, and the discharge chamber 208 may be considered downstream of the pressure chamber 207.

In operation, fluid is pressurized to a low pressure (e.g., 80 psi) by an outside system (e.g., a centrifugal pump) and pushed through the suction manifold 118 through the suction valve 202 and into the pressure chamber 207. The fluid is then pumped in response to a forward stroke of a plunger 120 and flows through the discharge valve 204.

In operation, the plunger 120 moves in a plunger bore 122 and is driven by the power end of the fluid pump. The power end includes a crankshaft that is rotated by a gearbox output, which may be a single gear or may be more than one gear. A gearbox input is coupled to a transmission and/or a prime mover, such as a diesel engine, to rotate the gearbox input during operation. A connecting rod mechanically connects the crankshaft to a crosshead via a wrist pin. The crosshead is mounted within a stationary crosshead housing, which constrains the crosshead to linear reciprocating movement. A pony rod connects to the crosshead and has its opposite end connected to the plunger 120 to enable reciprocating movement of the plunger 120. In some embodiments, the plunger 120 defines a cavity 124 (e.g., a plunger cavity). The cavity 124 may extend into an end of the plunger 120.

In operation, movement of the crankshaft causes the plunger 120 to reciprocate with respect to the bore 108 (e.g., to reciprocate toward and away from the bore 108). The plunger 120 may reciprocate with respect to the bore 108 between a full charge position (e.g., a first configuration) and a full discharge position (e.g., a second configuration). For example, the full charge position may be a position where a minimum portion of the plunger 120 is disposed within the bore 108 and the full discharge position may be a position where a maximum portion of the plunger 120 is disposed within the bore 108.

As the plunger 120 translates away from the bore 108 (a suction stroke of the plunger 120), the pressure of the fluid inside the pressure chamber 207 decreases, which creates a pressure differential across the suction valve 202. The pressure differential across the suction valve 202 enables actuation of the suction valve 202 to allow the fluid to enter the pressure chamber 207 from the suction manifold 118 (e.g., the suction valve 202 may open responsive to the pressure differential). The pumped fluid is pushed into the pressure chamber 207 as the plunger 120 continues to translate away from the bore 108. As the plunger 120 changes directions and moves toward the bore 108 (a discharge stroke of the plunger 120), the fluid pressure inside the pressure chamber 207 increases, which creates a pressure differential across the discharge valve 204. Fluid pressure inside the pressure chamber 207 continues to increase as the plunger 120 approaches the bore 108 until the pressure differential across the discharge valve 204 is great enough to actuate the discharge valve 204 and enable the fluid to exit the pressure chamber 207 (e.g., the valve may open responsive to the pressure differential).

The fluid end 100 may include a packing cartridge 300 disposed in the bore 108 (e.g., a respective packing cartridge 300 may be disposed in each bore 108 of the fluid end 100). For example, the packing cartridge 300 is configured for insertion into, and removal from, the bore 108 as a unit. The packing cartridge 300 may define the plunger bore 122. The packing cartridge 300 is configured to retain a packing 302 (e.g., a packing set, a packing assembly, or the like) in the bore 108 around the plunger 120. In some implementations, the packing 302 may be held in a packing sleeve. The packing 302 may include one or more rings (e.g., composed of polymer, metal, or another material) that circumferentially surround the plunger 120 and that are configured to prevent leakage of fluid from around the plunger 120. For example, the packing 302 may prevent leakage of fluid out of the plunger bore 122 from between the plunger 120 and the packing cartridge 300. In some examples, the fluid end 100 may include the packing 302 without the use of a packing cartridge 300.

As indicated above, FIG. 1 is provided as an example. Other examples may differ from what is described with regard to FIG. 1.

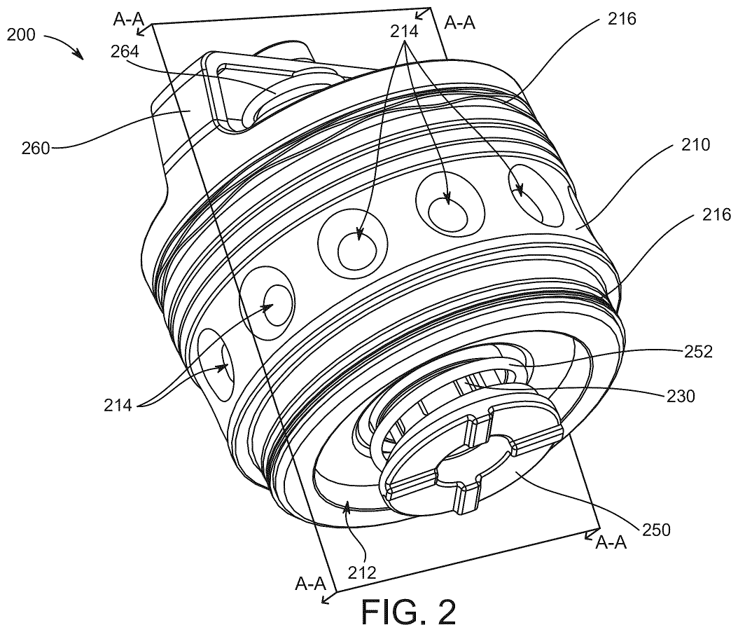

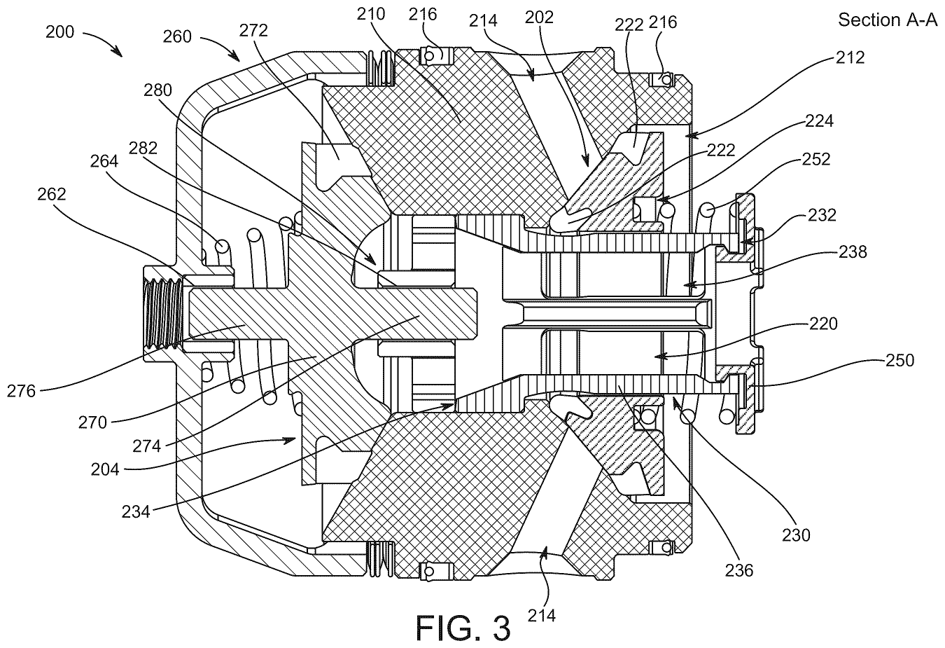

FIGS. 2 and 3 show an example of the valve cartridge 200. In particular, FIG. 2 is a perspective view of the valve cartridge 200 and FIG. 3 is a cross-sectional view of the valve cartridge 200 taken on plane A-A. The valve cartridge 200 includes the suction valve 202 and the discharge valve 204.

The valve cartridge 200 includes a valve cartridge housing 210. The valve cartridge housing 210 defines a fluid cavity 212 extending through the valve cartridge housing 210. The fluid cavity 212 is a passageway through the valve cartridge housing 210. For example, the fluid cavity 212 may extend from a first end of the valve cartridge housing 210 to an opposing second end of the valve cartridge housing 210. In some examples, at least one of the suction valve 202 or the discharge valve 204 is at least partially disposed within the fluid cavity 212. For example, the suction valve 202 may be disposed within the fluid cavity 212.

The valve cartridge housing 210 defines one or more passageways 214 extending at least partially through the valve cartridge housing 210. The passageways 214 open into the fluid cavity 212. For example, the passageways 214 may extend through sides of the valve cartridge housing 210 to the fluid cavity 212 such that fluid may flow from outside of the sides of the valve cartridge housing 210 into the fluid cavity 212. When the valve cartridge 200 is disposed in the bore 108, the passageways 214 may align with the suction manifold 118 (e.g., openings of the suction manifold 118) to selectively receive fluid from the suction manifold 118. For example, when the plunger 120 translates away from the bore 108, the fluid entering the pressure chamber 207 from the suction chamber 206 may flow through the passageways 214. In some examples, the passageways 214 at least partially define the suction chamber 206 of the bore 108.

The valve cartridge housing 210 is configured to retain one or more sealing elements 216 in the bore 108 around the valve cartridge housing 210. The sealing elements 216 may circumferentially surround the valve cartridge housing 210 and be configured to prevent leakage of fluid from around the valve cartridge housing 210. For example, the sealing elements 216 may prevent leakage of fluid out of the suction chamber 206 from between the valve cartridge housing 210 and the fluid end block 102. As another example, the sealing elements 216 may prevent leakage of fluid between the suction chamber 206 and the discharge chamber 208 from between the valve cartridge housing 210 and the fluid end block 102.

The suction valve 202 is configured to control flow from the passageways 214 into the fluid cavity 212 (e.g., from the suction chamber 206 of the bore 108 into the pressure chamber 207 of the bore 108). The suction valve 202 is adjustable between an open position (e.g., open configuration) that provides a flow path from the passageways 214 into the fluid cavity 212 and a closed position (e.g., closed configuration) that inhibits the flow path from the passageways 214 into the fluid cavity 212. The reciprocation of the plunger 120 may cause the suction valve 202 to adjust between the open position and the closed position. For example, when the plunger 120 translates away from the bore 108, the pressure differential across the suction valve 202 may cause the suction valve 202 to move from the closed position into the open position to provide the flow path from the passageways 214 into the fluid cavity 212. When the plunger 120 translates toward the bore 108, the suction valve 202 may move from the open position into the closed position to inhibit the flow path to prevent the fluid from flowing from the fluid cavity 212 into the passageways 214.

The suction valve 202 defines a central opening 220 extending through the suction valve 202. The central opening 220 is a passageway through the suction valve 202. For example, the central opening 220 may extend from a first end of the suction valve 202 to an opposing second end of the suction valve 202. At least a portion of the fluid flowing from the suction chamber 206 into the pressure chamber 207 and/or a portion of the fluid flowing from the pressure chamber 207 into the discharge chamber 208 may flow through the central opening 220.

The suction valve 202 includes one or more first sealing elements 222 configured to selectively inhibit the flow of the fluid from the passageways 214 into the fluid cavity 212. When the suction valve 202 is in the closed position, the first sealing elements 222 contact the valve cartridge housing 210 to form first seals between the first sealing elements 222 and the valve cartridge housing 210 such that the fluid cannot flow between the passageways 214 and the fluid cavity 212. A first of the first sealing elements 222 may contact the valve cartridge housing 210 on a first side of the passageways 214 and a second of the first sealing elements 222 may contact the valve cartridge housing 210 on a second side of the passageways 214 to form the first seals to prevent the flow of fluid between the passageways 214 and the fluid cavity 212.

In some examples, the suction valve 202 defines a groove 224 surrounding the central opening 220. The groove 224 extends into a backside of the suction valve 202 (e.g., a non-sealing side of the suction valve 202). For example, when the suction valve 202 is in the closed position, the first sealing elements 222 on a front side of the suction valve 202 may form the first seals between the first sealing elements 222 and the valve cartridge housing 210 and the groove 224 may be defined in an opposing backside of the suction valve 202.

The valve cartridge includes a guiding insert 230 extending through the central opening 220 of the suction valve 202. For example, at least a portion of the guiding insert 230 may be received by the central opening 220 of the suction valve 202. The guiding insert 230 slidably engages the suction valve 202. For example, the suction valve 202 may slide along the guiding insert 230 when the suction valve 202 moves between the closed position and the open position. When the suction valve 202 is in the closed position, the slidable engagement between the suction valve 202 and the guiding insert 230 may at least partially center the suction valve 202 relative to the valve cartridge housing 210 to ensure proper formation of the first seals between the suction valve 202 and the valve cartridge housing 210.

The guiding insert 230 includes a first end 232 (e.g., an end) and an opposing second end 234 (e.g., an opposite end). The second end 234 of the guiding insert 230 is disposed within the fluid cavity 212. In some examples, the first end 232 of the guiding insert 230 is positioned outside of the fluid cavity 212.

The guiding insert 230 includes a sidewall 236. The sidewall 236 extends from the first end 232 of the guiding insert 230 to the second end 234 of the guiding insert 230. The sidewall 236 slidably engages the suction valve 202. For example, the suction valve 202 may slide along an outside surface of the sidewall 236 when the suction valve 202 moves between the closed position and the open position. The sidewall 236 defines a flow channel 238 through the guiding insert 230. The flow channel 238 is a passageway through the guiding insert 230. For example, the flow channel 238 may extend from the first end 232 of the guiding insert 230 to the second end 234 of the guiding insert 230.

The second end 234 of the guiding insert 230 is engaged with the valve cartridge housing 210 along the fluid cavity 212. For example, the second end 234 of the guiding insert 230 may include a ledge with a first diameter that is larger than a second diameter of the first end 232 of the guiding insert 230. The ledge at the second end 234 of the guiding insert 230 may interface with another ledge of the valve cartridge housing 210 to engage the guiding insert 230 with the valve cartridge housing 210 along the fluid cavity 212. As another example, the second end 234 of the guiding insert 230 may form an interference fit with the fluid cavity 212 of the valve cartridge housing 210 to engage the guiding insert 230 with the valve cartridge housing 210. The engagement between the guiding insert 230 and the valve cartridge housing 210 may allow movement of the guiding insert 230 relative to the valve cartridge housing 210 in a first direction (e.g., away from the suction valve 202) and inhibit movement of the guiding insert 230 relative to the valve cartridge housing 210 in an opposing second direction (e.g., toward the suction valve 202).

The valve cartridge 200 includes a spring retainer 250 coupled to the first end 232 of the guiding insert 230. For example, the spring retainer 250 may include a first lip configured to engage a second lip of the guiding insert 230 at the first end 232 of the guiding insert 230 to couple the spring retainer 250 to the first end 232 of the guiding insert 230. As another example, the spring retainer 250 may include first engagement portions configured to align with second engagement portions of the guiding insert 230 and engage the second engagement portions of the guiding insert 230 by turning the spring retainer 250 (e.g., a quarter turn) to couple the spring retainer 250 to the guiding insert 230.

The spring retainer 250 may retain a first spring 252 between the spring retainer 250 and the suction valve 202. For example, the first spring 252 may be positioned between the spring retainer 250 and the backside of the suction valve 202. The first spring 252 may be disposed around at least a portion of the guiding insert 230. For example, the suction valve 202 may inhibit movement of the first spring 252 in a first direction, the spring retainer 250 may inhibit movement of the first spring 252 in an opposing second direction, and the first spring 252 being wrapped around the guiding insert 230 may inhibit movement of the first spring 252 in directions perpendicular to the first direction and the second direction. The first spring 252 may be partially disposed in the groove 224 in the backside of the suction valve 202.

The spring retainer 250 is configured to bias the suction valve 202 towards the closed position using the first spring 252. For example, when the suction valve 202 moves towards the open position, the suction valve 202 may compress the first spring 252 against the spring retainer 250. The compression of the first spring 252 may cause the first spring 252 to apply a compression force on the suction valve 202 in a direction of travel of the suction valve 202 from the open position towards the closed position to bias the suction valve 202 towards the closed position. When the plunger 120 creates a pressure differential across the suction valve 202 (e.g., when a pressure differential between the suction chamber 206 and the pressure chamber 207 exceeds a pressure threshold associated with the first spring 252), the suction valve 202 may move from the closed position toward the open position to allow the flow of fluid from the suction chamber 206 into the pressure chamber 207. When the pressure differential across the suction valve 202 equalizes, the first spring 252 may move the suction valve 202 towards the closed position to inhibit the flow of fluid from the pressure chamber 207 back into the suction chamber 206. In some examples, when the plunger 120 is in the full discharge position, the cavity 124 of the plunger 120 receives the spring retainer 250. For example, when the plunger 120 is in the full discharge position, the cavity 124 of the plunger 120 may receive the spring retainer 250, at least a portion of the guiding insert 230, and/or at least a portion of the first spring 252. Thus, the cavity 124 accommodates parts of the valve cartridge 200 that extend beyond the cartridge housing 210 without the need to shorten the plunger 120 and affect its stroke length, which would impact several performance characteristics of the fluid pump.

The discharge valve 204 is configured to selectively seal an end of the valve cartridge housing 210 to control flow out from the fluid cavity 212 (e.g., from the pressure chamber 207 of the bore 108 into the discharge chamber 208 of the bore 108). For example, the discharge valve 204 may selectively seal the end of the valve cartridge housing 210 to inhibit flow of fluid from the pressure chamber 207 into the discharge chamber 208. In some examples, a portion of the discharge valve 204 is disposed within the fluid cavity 212.

The discharge valve 204 is adjustable between an open position (e.g., an open configuration) that provides a flow path out of the fluid cavity 212 (e.g., a flow path from the pressure chamber 207 into the discharge chamber 208) and a closed position (e.g., a closed configuration) that inhibits the flow path out of the fluid cavity 212. The reciprocation of the plunger 120 may cause the discharge valve 204 to adjust between the closed position and the open position. For example, when the plunger 120 translates away from the bore 108, the pressure in the pressure chamber 207 may be below a pressure threshold needed to actuate the discharge valve 204 from the closed position to the open position and the discharge valve 204 may inhibit the flow path to prevent the fluid from flowing out of the fluid cavity 212. When the plunger 120 translates towards the bore 108, the pressure in the pressure chamber 207 may increase until the pressure exceeds the pressure threshold and the discharge valve 204 moves from the closed position towards the open position to provide the flow path out of the fluid cavity 212.

The valve cartridge 200 includes a retention bracket 260 coupled to the valve cartridge housing 210. The discharge valve 204 may be positioned between the retention bracket 260 and the valve cartridge housing 210. For example, the discharge valve 204 may be retained between the retention bracket 260 and the valve cartridge housing 210. The retention bracket 260 defines a retention aperture 262 extending through the valve body discharge valve body. The retention bracket 260 slidably engages the discharge valve 204. For example, the discharge valve 204 may slide through the retention aperture 262 when the discharge valve 204 moves between the closed position and the open position.

The retention bracket 260 may retain a second spring 264 between the retention bracket 260 and the discharge valve 204. For example, the second spring 264 may be positioned between the retention bracket 260 and the discharge valve 204.

The retention bracket 260 is configured to bias the discharge valve 204 towards the closed position using the second spring 264. For example, when the discharge valve 204 moves towards the open position, the discharge valve 204 may compress the second spring 264 against the retention bracket 260. The compression of the second spring 264 may cause the second spring 264 to apply a compression force on the discharge valve 204 in a direction of travel of the discharge valve 204 from the open position towards the closed position to bias the discharge valve 204 towards the closed position. When the plunger 120 creates a pressure differential across the discharge valve 204 (e.g., a pressure differential between the pressure chamber 207 and the discharge chamber 208 exceeds a pressure threshold associated with the second spring 264), the suction valve 202 may move from the closed position toward the open position to allow the flow of fluid from the suction chamber 206 into the pressure chamber 207. When the pressure differential across the discharge valve 204 equalizes, the second spring 264 may move the discharge valve 204 towards the closed position to inhibit the flow of fluid from the discharge chamber 208 back into the pressure chamber 207.

The discharge valve 204 includes a discharge valve body 270. The discharge valve body 270 includes a second sealing element 272 configured to selectively inhibit the flow of the fluid out of the fluid cavity 212. When the discharge valve 204 is in the closed position, the second sealing element 272 contacts the valve cartridge housing 210 to form a second seal between the discharge valve body 270 and the valve cartridge housing 210 such that the fluid cannot flow out of the fluid cavity 212.

The discharge valve 204 includes a first valve stem 274 extending from a first side of the discharge valve body 270 and a second valve stem 276 extending from an opposing second side of the discharge valve body 270. The second valve stem 276 is configured to be received by the retention aperture 262 to slidably engage the discharge valve 204 with the retention bracket 260. For example, the second valve stem 276 may slide through the retention aperture 262 when the discharge valve 204 moves between the closed position and the open position. When the discharge valve 204 is in the closed position, the slidable engagement between the second valve stem 276 and the retention aperture 262 may at least partially center the discharge valve 204 relative to the valve cartridge housing 210 to ensure proper formation of the second seal between the discharge valve 204 and the valve cartridge housing 210.

The second spring 264 may be disposed around at least a portion of the second valve stem 276. For example, the discharge valve 204 may inhibit movement of the second spring 264 in a first direction, the retention bracket 260 may inhibit movement of the second spring 264 in an opposing second direction, and the second spring 264 being disposed around the second valve stem 276 may inhibit movement of the second spring 264 in directions perpendicular to the first direction and the second direction.

The valve cartridge includes a valve guide 280. The valve guide 280 is positioned within the fluid cavity 212. The valve guide 280 may be positioned within the fluid cavity 212 downstream of the guiding insert 230. The valve guide 280 may abut the guiding insert 230. For example, the valve guide 280 may abut the second end 234 of the guiding insert 230. The valve guide 280 is slidably engaged with the first valve stem 274. For example, the first valve stem 274 may slide relative to the valve guide 280 as the discharge valve 204 moves between the open position and the closed position.

The valve guide 280 defines a valve guide aperture 282 extending through the valve guide 280. The valve guide aperture 282 is configured to receive the first valve stem 274 to slidably engage the discharge valve 204 with the valve guide 280. For example, the first valve stem 274 may slide through the valve guide aperture 282 when the discharge valve 204 moves between the closed position and the open position. When the discharge valve 204 is in the closed position, the slidable engagement between the first valve stem 274 and the valve guide aperture 282 may at least partially center the discharge valve 204 relative to the valve cartridge housing 210 to ensure proper formation of the second seal between the discharge valve 204 and the valve cartridge housing 210.

In some examples, the valve guide 280 and the guiding insert 230 form a unitary part. For example, the valve guide 280 and the guiding insert 230 may be formed of a single piece of continuous material (e.g., a unitary constructed component).

As indicated above, FIGS. 2 and 3 are provided as an example. Other examples may differ from what is described in connection with FIGS. 2 and 3.

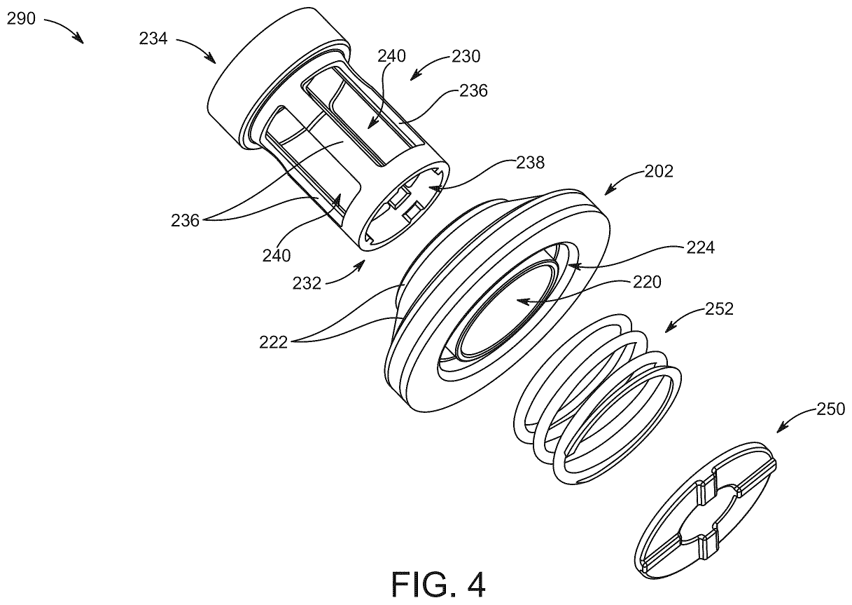

FIG. 4 is an exploded view of a valve assembly 290 of the valve cartridge 200. The valve assembly 290 includes the suction valve 202, the guiding insert 230, the spring retainer 250, and the first spring 252. The valve assembly 290 may be a disposable valve assembly that is removable from the valve cartridge housing 210 and replaceable with another of the valve assemblies 290 to extend an operational lifespan of other components of the valve cartridge 200 and/or the fluid end 100 (e.g., the fluid end block 102, the plunger 120, the packing cartridge 300, the valve cartridge housing 210, the discharge valve 204).

The suction valve 202 defines the central opening 220 and the groove 224. The suction valve 202 includes the first sealing elements 222.

The guiding insert 230 has the first end 232 and the second end 234. The guiding insert 230 includes the sidewall 236 extending from the first end 232 to the second end 234. The sidewall 236 defines the flow channel 238 through the guiding insert 230. In some examples, the sidewall 236 is configured with an open frame having one or more openings 240 (e.g., one or more windows) into the flow channel 238. For example, the open frame of the sidewall 236 may include multiple legs extending at least partially along a length of the guiding insert 230 between the first end 232 and the second end 234 and each of the legs may be spaced apart by the openings 240. The openings 240 may allow for flow of fluid from outside the sidewall 236 into the flow channel 238. For example, when the pressure chamber 207 receives a flow of fluid from the suction chamber 206, the fluid may flow along a flow path from the suction chamber 206 through the openings 240 and into the flow channel 238.

When the suction valve 202 is in the closed position, the suction valve 202 covers (e.g., seals) at least a portion of the openings 240 of the guiding insert 230. For example, when the suction valve 202 is in the closed position (e.g., during a discharge cycle of the fluid end 100) the central opening 220 of the suction valve 202 may align with a portion of the openings 240 of the guiding insert 230 to inhibit a flow of fluid through the portion of the openings 240. By inhibiting the flow of fluid through the portion of the openings 240, the suction valve 202 may reduce a turbulence of the flow of fluid flowing from the pressure chamber 207 into the discharge chamber 208 through the fluid cavity 212 and/or may reduce a wear on the valve cartridge housing 210 from the flow of fluid flowing from the pressure chamber 207 into the discharge chamber 208 through the fluid cavity 212. In some examples, when the suction valve 202 is in the closed position, the suction valve 202 is configured to selectively seal the openings 240 of the guiding insert 230 to inhibit flow through the openings 240.

As indicated above, FIG. 4 is provided as an example. Other examples may differ from what is described with regard to FIG. 4.

### INDUSTRIAL APPLICABILITY

The valve assembly 290 described herein may be used with any positive displacement fluid pump (e.g., a reciprocating positive displacement fluid pump). For example, a hydraulic fracturing pump may use the valve assembly 290 described herein to facilitate the pressurization of hydraulic fracturing fluid for hydraulic fracturing operations used to recover water, oil, natural gas, and/or other fluids from a rock formation. In one example, the valve assembly 290 may be employed in the valve cartridge 200, which is configured for insertion into, and removal from, the bore 108 of the fluid end 100 as a unit. Generally, the valves of a fluid pump may have guiding components (e.g., legs and/or valve stems) that slide along a surface to keep the valves centered with respect to valve seats, thereby facilitating fluid tight sealing. However, even slight vertical or lateral movement of a valve that is allowed by a guiding component can result in excessive strike face wear and premature seal failure. This effect can be exacerbated when operating at very high pressures, such as used in hydraulic fracturing.

The valve assembly 290 described herein is useful for maintaining proper alignment of the suction valve 202 during operation of the fluid end 100 of a fluid pump. For example, the guiding insert 230 of the valve assembly 290 minimizes lateral movement of the suction valve 202 during opening and closing of the suction valve 202. In this way, the valve assembly 290 extends a useful life of the suction valve 202 and of the valve cartridge 200. Moreover, positioning the guiding insert 230 through the central opening 220 of the suction valve 202 allows the suction valve 202 to be relatively short, which enables reducing the overall length of the valve cartridge 200. This conserves material used in manufacturing the valve cartridge 200, and allows the valve cartridge 200 to be light weight, thereby facilitating easier installation and removal of the valve cartridge 200 from the fluid end 100 and reducing overall pump weight.

The foregoing describes only some embodiments, and alterations, modifications, additions and/or changes can be made thereto without departing from the scope and spirit of the disclosed embodiments, the embodiments being illustrative and not restrictive. Furthermore, implementations are not limited to the disclosed embodiments, and may cover various modifications and equivalent arrangements included within the spirit and scope of the disclosed embodiments. Also, the various embodiments described above may be implemented in conjunction with other embodiments, for example, aspects of one embodiment may be combined with aspects of another embodiment to realize yet other embodiments. Further, each independent feature or component of any given assembly or process may constitute an additional embodiment. As used herein, the singular forms of “a,” “an,” and “the” include plural referents unless the context clearly dictates otherwise. In addition, as used herein, the term “or” means “and/or” unless the context clearly dictates otherwise.

Further, spatially relative terms, such as “upper,” “lower,” “top,” “bottom,” “left,” “right,” etc., may be used herein to describe one element or feature's relationship to another element(s) or feature(s) as illustrated in the figures. The spatially relative terms are intended to encompass different orientations in use or operation in addition to the orientation(s) depicted in the figures. Accordingly, the spatially relative terms may be interpreted in a corresponding manner to rotations of the orientation(s) depicted in the figures.

What is claimed is:

1. A valve cartridge for a fluid pump, comprising:
a valve cartridge housing having one or more passageways through the valve cartridge housing that open into a fluid cavity defined in the valve cartridge housing;
an annular suction valve configured to control flow from the one or more passageways into the fluid cavity, the annular suction valve having a central opening;
a guiding insert extending through the central opening and slidably engaging the annular suction valve; and
a spring retainer coupled to an end of the guiding insert and retaining a spring between the spring retainer and a backside of the annular suction valve.

2. The valve cartridge of claim 1, wherein the guiding insert comprises a sidewall that defines a flow channel through the guiding insert.

3. The valve cartridge of claim 2, wherein the sidewall is configured with an open frame having one or more openings into the flow channel.

4. The valve cartridge of claim 2, wherein an open position of the annular suction valve provides a flow path from the one or more passageways into the flow channel of the guiding insert.

5. The valve cartridge of claim 2, wherein a closed position of the annular suction valve provides a flow path through the flow channel of the guiding insert.

6. The valve cartridge of claim 1, wherein an opposite end of the guiding insert is engaged with the valve cartridge housing along the fluid cavity.

7. The valve cartridge of claim 1, wherein the spring is partially disposed in a groove surrounding the central opening in a backside of the annular suction valve.

8. The valve cartridge of claim 1, further comprising:
a discharge valve comprising a valve stem, the discharge valve configured to seal an end of the valve cartridge housing to control flow out from the fluid cavity; and
a valve guide slidably engaging with the valve stem.

9. The valve cartridge of claim 8, wherein the guiding insert abuts the valve guide.

10. The valve cartridge of claim 8, wherein the guiding insert and the valve guide form a unitary part.

11. A valve assembly, comprising:
an annular suction valve having a central opening and a groove surrounding the central opening in a backside of the annular suction valve;
a guiding insert extending through the central opening and slidably engaging the annular suction valve;
a spring partially disposed in the groove; and
a spring retainer coupled to an end of the guiding insert and retaining the spring between the spring retainer and the backside of the annular suction valve.

12. The valve assembly of claim 11, wherein the guiding insert comprises a sidewall that defines a flow channel through the guiding insert.

13. The valve assembly of claim 12, wherein the sidewall is configured with an open frame having one or more openings into the flow channel.

14. The valve assembly of claim 11, wherein the annular suction valve includes one or more sealing elements, each of the sealing elements configured to contact a surface to form a seal.

15. A fluid end of a hydraulic fracturing pump, comprising:
a fluid end block having a bore;
a plunger configured to reciprocate with respect to the bore; and
a valve cartridge, configured for insertion and removal from the bore as a unit, comprising:
a valve cartridge housing;
a fluid cavity defined in the valve cartridge housing; and
a valve assembly, comprising:
an annular suction valve configured to control flow into the fluid cavity, the annular suction valve having a central opening; and
a guiding insert, engaged with the valve cartridge housing along the fluid cavity, extending through the central opening and slidably engaging the annular suction valve.

16. The fluid end of claim 15, wherein the valve assembly further comprises:
a spring; and
a spring retainer coupled to an end of the guiding insert and retaining the spring between the spring retainer and a backside of the annular suction valve.

17. The fluid end of claim 16, wherein the plunger has a cavity configured to receive at least the spring retainer in a full discharge position of the plunger.

18. The fluid end of claim 15, wherein the valve cartridge further comprises:
a discharge valve comprising a first valve stem, the discharge valve configured to seal an end of the valve cartridge housing to control flow out from the fluid cavity; and
a valve guide slidably engaging with the first valve stem, the valve guide abutting the guiding insert.

19. The fluid end of claim 15, wherein the guiding insert comprises a sidewall that defines a flow channel through the guiding insert, the sidewall configured with an open frame having one or more openings into the flow channel.

20. The fluid end of claim 15, wherein the valve cartridge housing has one or more passageways through the valve cartridge housing that open into the fluid cavity,
wherein an open position of the annular suction valve provides a flow path from the one or more passageways into the fluid cavity, and
wherein a closed position of the annular suction valve inhibits the flow path from the one or more passageways into the fluid cavity.
